(19) United States
(12) Patent Application Publication
(10) Pub. No.: US 2024/0152730 A1
(43) Pub. Date: May 9, 2024

(54) SYSTEMS AND METHODS FOR DETERMINING DRUG POTENTCY USING MACHINE LEARNING ALGORITHMS

(71) Applicant: CVS Pharmacy, Inc., Woonsocket, RI (US)

(72) Inventors: Dwayne Kurfirst, Woonsocket, RI (US); Neal Shah, Woonsocket, RI (US); Tulsi Patel, Woonsocket, RI (US); Clark D. Peterson, Woonsocket, RI (US); Matthew C. Van Allen, Woonsocket, RI (US); Alan Bachmann, Woonsocket, RI (US); Ajay Behuria, Woonsocket, RI (US); Harpreet Kaur, Woonsocket, RI (US); Robert W. Goldman, Woonsocket, RI (US); Katharine R. Flanagan, Woonsocket, RI (US); Zainab Salahudin, Woonsocket, RI (US); Kamya Menon, Woonsocket, RI (US)

(21) Appl. No.: 17/982,961

(22) Filed: Nov. 8, 2022

(51) Int. Cl. G06N 3/04; G06N 3/08; G06N 20/00; G06T 7/00

(52) U.S. Cl. CPC G06N 3/0454; G06N 3/08; G06N 20/00; G06T 7/0012; G06T 2207/10048

(57) ABSTRACT

A system comprising a first expired drug usability device is provided. The first expired drug usability device comprises a first spectrometer and one or more first processors. The first processors are configured to: obtain at least one expired drug machine learning-artificial intelligence (ML-AI) model associated with a pharmaceutical drug; obtain drug expiration information of a sample of the pharmaceutical drug, wherein the drug expiration information comprises spectrometer data associated with using the first spectrometer on the sample; input the drug expiration information into the at least one expired drug ML-AI model to determine usability information associated with the sample of the pharmaceutical drug; and perform one or more actions based on the usability information.

### BACKGROUND

Medications typically have an expiration date provided by the manufacturer, which informs pharmacies when they should distribute the medication by and/or informs the user when to use the medication by. After the expiration date, the medication or drug might not be as effective in treating the disease or medical condition. For instance, a prescription of a drug may indicate for the user to take one tablet of the drug every day for the next two months. After the expiration date, the potency of the drug may decrease (e.g., after six months past the expiration date, the drug potency may decrease by 70%). Accordingly, after expiration, the user might not be taking the correct drug dosage given the decrease in drug potency. As such, prescription providers (e.g., pharmacies, retail stores, and/or distribution centers) generally provide medications to the user prior to the expiration date. However, due to some circumstances, the prescription providers may still have the medication in stock even after the expiration date of the medication. Conventionally, the prescription providers may dispose of these medications. However, the medications may still be effective, even though the drug potency may have decreased by a certain amount. Accordingly, there remains a technical need to determine the drug potency and/or usage of the medication after the expiration date of the medication.

### SUMMARY

In some examples, the present application may determine usability information for a particular drug (e.g., medication) after the expiration date of the drug using one or more machine learning or artificial intelligence algorithms, models, and/or datasets (e.g., ML-AI models). For instance, the present application may use one or more expired drug usability devices to train the ML-AI models and use the ML-AI models. For example, the expired drug usability device may use one or more sensors or devices (e.g., a spectrometer and/or an olfactory sensor) to obtain training information. The expired drug usability device may train one or more ML-AI models (e.g., a spectrometer ML-AI model, a signal-to-noise ratio (SNR) ML-AI model, and/or an olfactory ML-AI model) using the training information. After training, the expired drug usability device may provide the trained ML-AI models to another expired drug usability device, which uses the trained ML-AI models to determine the drug potency of the drug. For instance, the expired drug usability device that trains the ML-AI models may be at a distribution center (DC), and this expired drug usability device may provide the trained ML-AI models to another expired drug usability device at a pharmacy (e.g., a local pharmacy). The pharmacy's drug usability device may obtain drug expiration information of a sample of the drug, and use the trained ML-AI models to determine the usability of the sample of the drug. Then, the drug usability device may perform one or more actions based on the usability of the sample of the drug. This and other examples will be described in further detail below.

In one aspect, a system comprising a first expired drug usability device is provided. The first expired drug usability device comprises: a first spectrometer; and one or more first processors configured to: obtain at least one expired drug machine learning-artificial intelligence (ML-AI) model associated with a pharmaceutical drug; obtain drug expiration information of a sample of the pharmaceutical drug, wherein the drug expiration information comprises spectrometer data associated with using the first spectrometer on the sample; input the drug expiration information into the at least one expired drug ML-AI model to determine usability information associated with the sample of the pharmaceutical drug; and perform one or more actions based on the usability information.

Examples may include one of the following features, or any combination thereof. For instance, in some examples, the system further comprises: a second expired drug usability device, comprising: a second spectrometer; and one or more second processors configured to: train the at least one expired drug ML-AI model; and provide the at least one expired drug ML-AI model to the first expired drug usability device.

In some instances, the at least one expired drug ML-AI model comprises a spectrometer ML-AI model, and wherein the one or more second processors is configured to train the at least one expired drug ML-AI model by: obtaining spectrometer ML-AI training information comprising spectrometer output data of the pharmaceutical drug at difference instances within a life expectancy of the pharmaceutical drug; and training the spectrometer ML-AI model using the spectrometer ML-AI training information.

In some variations, the one or more second processors is configured to obtain the spectrometer ML-AI training information by: obtaining first spectrometer output data of the second spectrometer associated with testing a first lot of the pharmaceutical drug, wherein the first lot of the pharmaceutical drug is at an expiration date of the pharmaceutical drug; obtaining second spectrometer output data of the second spectrometer associated with testing a second lot of the pharmaceutical drug, wherein the second lot of the pharmaceutical drug is prior to the expiration date of the pharmaceutical drug; and obtaining third spectrometer output data of the second spectrometer associated with testing a third lot of the pharmaceutical drug, wherein the third lot of the pharmaceutical drug is after the expiration date of the pharmaceutical drug.

In some examples, the at least one expired drug ML-AI model further comprises a signal to noise (SNR) ML-AI model, wherein the one or more second processors is configured to train the at least one expired drug ML-AI model by: determining, based on the spectrometer output data, SNR ML-AI training information of the pharmaceutical drug at difference instances within the life expectancy of the pharmaceutical drug; and training the SNR ML-AI model using the SNR ML-AI training information.

In some instances, the at least one expired drug ML-AI model further comprises an olfactory ML-AI model, wherein the one or more second processors is configured to train the at least one expired drug ML-AI model by: obtaining olfactory ML-AI training information comprising olfactory sensor output data of the pharmaceutical drug at difference instances within the life expectancy of the pharmaceutical drug; and training the olfactory ML-AI model using the olfactory ML-AI training information.

In some variations, the at least one expired drug ML-AI model comprises a spectrometer ML-AI model, a SNR ML-AI model, and an olfactory ML-AI model, and wherein the drug expiration information of the sample of the pharmaceutical drug comprises the spectrometer data of the sample of the pharmaceutical drug, SNR data of the sample of the pharmaceutical drug, and olfactory data of the sample of the pharmaceutical drug.

In some examples, the one or more first processors is configured to input the drug expiration information into the at least one expired drug ML-AI model to determine the usability information of the sample of the pharmaceutical drug by: inputting the spectrometer data into the spectrometer ML-AI model to determine spectrometer usability information; inputting the SNR data into the SNR ML-AI model to determine SNR usability information; inputting the olfactory data into the olfactory ML-AI model to determine olfactory usability information; and determining the usability information based on the spectrometer usability information, the SNR usability information, and the olfactory usability information.

In some instances, the spectrometer usability information is a first usability confidence value that is output by the spectrometer ML-AI model, the SNR usability information is a second usability confidence value that is output by the SNR ML-AI model, and the olfactory usability information is a third usability confidence value that is output by the olfactory ML-AI model.

In some variations, the one or more first processors configured to determine the usability information by: determining the usability information as a weighted average of the first usability confidence value, the second usability confidence value, and the third usability confidence value.

In some examples, the first spectrometer is a liquid spectrometer.

In some instances, the first spectrometer is a near infrared (NIR) spectrometer.

In another aspect, a method is provided. The method comprises: obtaining, by an expired drug usability device, at least one expired drug machine learning-artificial intelligence (ML-AI) model associated with a pharmaceutical drug; obtaining, by the expired drug usability device, drug expiration information of a sample of the pharmaceutical drug, wherein the drug expiration information comprises spectrometer data associated with using a spectrometer on the sample; inputting, by the expired drug usability device, the drug expiration information into the at least one expired drug ML-AI model to determine usability information associated with the sample of the pharmaceutical drug; and performing, by the expired drug usability device, one or more actions based on the usability information.

Examples may include one of the following features, or any combination thereof. For instance, in some examples, the at least one expired drug ML-AI model comprises a spectrometer ML-AI model, and wherein the method further comprises: obtaining spectrometer ML-AI training information comprising spectrometer output data of the pharmaceutical drug at difference instances within a life expectancy of the pharmaceutical drug; and training the spectrometer ML-AI model using the spectrometer ML-AI training information.

In some instances, obtaining the spectrometer ML-AI training information comprises: obtaining first spectrometer output data associated with testing a first lot of the pharmaceutical drug, wherein the first lot of the pharmaceutical drug is at an expiration date of the pharmaceutical drug; obtaining second spectrometer output data associated with testing a second lot of the pharmaceutical drug, wherein the second lot of the pharmaceutical drug is prior to the expiration date of the pharmaceutical drug; and obtaining third spectrometer output data associated with testing a third lot of the pharmaceutical drug, wherein the third lot of the pharmaceutical drug is after the expiration date of the pharmaceutical drug.

In some variations, the at least one expired drug ML-AI model further comprises a signal to noise (SNR) ML-AI model, wherein the method further comprises: determining, based on the spectrometer output data, SNR ML-AI training information of the pharmaceutical drug at difference instances within the life expectancy of the pharmaceutical drug; and training the SNR ML-AI model using the SNR ML-AI training information.

In some instances, the at least one expired drug ML-AI model further comprises an olfactory ML-AI model, wherein the method further comprises: obtaining olfactory ML-AI training information comprising olfactory sensor output data of the pharmaceutical drug at difference instances within the life expectancy of the pharmaceutical drug; and training the olfactory ML-AI model using the olfactory ML-AI training information.

In some examples, the at least one expired drug ML-AI model comprises a spectrometer ML-AI model, a SNR ML-AI model, and an olfactory ML-AI model, and wherein the drug expiration information of the sample of the pharmaceutical drug comprises the spectrometer data of the sample of the pharmaceutical drug, SNR data of the sample of the pharmaceutical drug, and olfactory data of the sample of the pharmaceutical drug.

In some variations, inputting the drug expiration information into the at least one expired drug ML-AI model to determine the usability information of the sample of the pharmaceutical drug comprises: inputting the spectrometer data into the spectrometer ML-AI model to determine spectrometer usability information; inputting the SNR data into the SNR ML-AI model to determine SNR usability information; inputting the olfactory data into the olfactory ML-AI model to determine olfactory usability information; and determining the usability information based on the spectrometer usability information, the SNR usability information, and the olfactory usability information.

In yet another aspect, a non-transitory computer-readable medium having processor-executable instructions stored thereon is provided. The processor-executable instructions, when executed, facilitate: obtaining at least one expired drug machine learning-artificial intelligence (ML-AI) model associated with a pharmaceutical drug; obtaining drug expiration information of a sample of the pharmaceutical drug, wherein the drug expiration information comprises spectrometer data associated with using a spectrometer on the sample; inputting the drug expiration information into the at least one expired drug ML-AI model to determine usability information associated with the sample of the pharmaceutical drug; and performing one or more actions based on the usability information.

All examples and features mentioned above may be combined in any technically possible way.

### BRIEF DESCRIPTION OF THE DRAWINGS

The subject technology will be described in even greater detail below based on the exemplary figures, but is not limited to the examples. All features described and/or illustrated herein can be used alone or combined in different combinations. The features and advantages of various examples will become apparent by reading the following detailed description with reference to the attached drawings which illustrate the following:

FIG. 1 is a simplified block diagram depicting an exemplary computing environment in accordance with one or more examples of the present application.

FIG. 2 is a simplified block diagram of one or more devices or systems within the exemplary environment of FIG. 1.

FIG. 3 is a simplified block diagram depicting an exemplary expired drug usability device in accordance with one or more examples of the present application.

FIG. 4 is an exemplary process for using the expired drug usability device to determine usability of a drug in accordance with one or more examples of the present application.

FIGS. 5A-5C are exemplary processes for using the expired drug usability device to determine usability of the drug in accordance with one or more examples of the present application.

FIG. 6 is another exemplary process for using the expired drug usability device to determine usability of a drug in accordance with one or more examples of the present application.

### DETAILED DESCRIPTION

Examples of the presented application will now be described more fully hereinafter with reference to the accompanying FIGs., in which some, but not all, examples of the application are shown. Indeed, the application may be exemplified in different forms and should not be construed as limited to the examples set forth herein; rather, these examples are provided so that the application will satisfy applicable legal requirements. Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

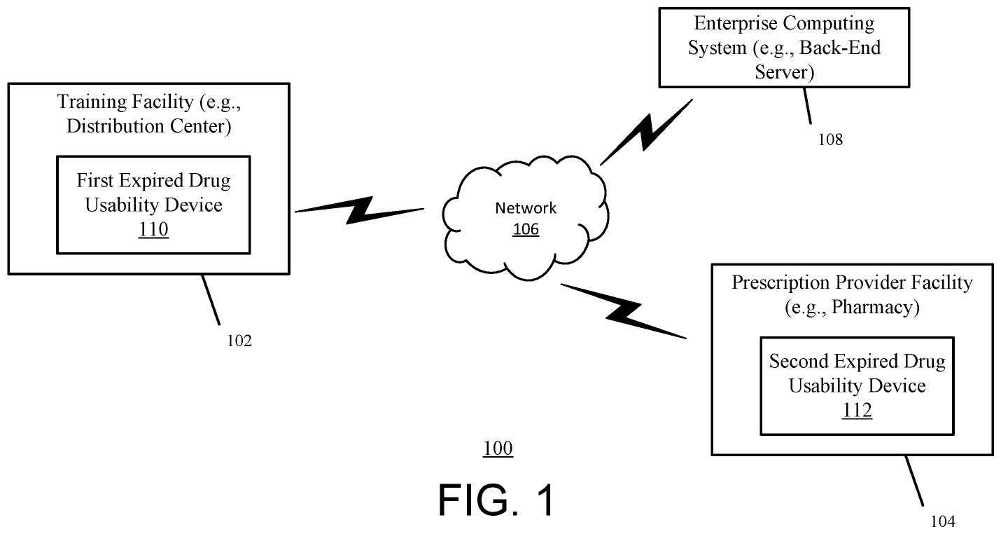

Systems, methods, and computer program products are herein disclosed that use one or more expired drug usability devices to determine usability of expired drugs using one or more ML-AI models. FIG. 1 is a simplified block diagram depicting an exemplary environment in accordance with an example of the present application. The environment 100 includes a training facility 102 (e.g., a distribution center (DC)), a prescription provider facility 104 (e.g., a pharmacy or retail store), and an enterprise computing system 108 (e.g., a back-end server). Although the entities within environment 100 may be described below and/or depicted in the FIGs. as being singular entities, it will be appreciated that the entities and functionalities discussed herein may be implemented by and/or include one or more entities.

The entities within the environment 100 such as the training facility 102, the prescription provider facility 104, and/or the enterprise computing system 108 may be in communication with other systems or facilities within the environment 100 via the network 106. The network 106 may be a global area network (GAN) such as the Internet, a wide area network (WAN), a local area network (LAN), or any other type of network or combination of networks. The network 106 may provide a wireline, wireless, or a combination of wireline and wireless communication between the entities within the environment 100. For instance, the training facility 102 includes a first expired drug usability device 110 and the prescription provider facility includes a second expired drug usability device 112. The first expired drug usability device 110 may be in communication with the second expired drug usability device 112 using the network 106. In some instances, the first and second expired drug usability devices 110 and 112 may be similar, including having similar and/or the same components such as one or more spectrometers and/or one or more olfactory sensors. Additionally, and/or alternatively, the first expired drug usability device 110 and the second expired drug usability device 112 may communicate with each other and/or other entities within environment 100 (e.g., the enterprise computing system 108) without using the network 106 (e.g., via communication protocols such as WI-FI or BLUETOOTH).

The enterprise computing system 108 is a computing system that is associated with an enterprise organization. The enterprise organization may be any type of corporation, company, organization, and/or other institution. In some instances, the enterprise organization may own, operate, and/or be otherwise associated with distribution of drugs, medications, and/or other substances that may have an effect when ingested or introduced into a user. The drug (e.g., the pharmaceutical drug) may have an expiration date associated with the drug, which, in some instances, may be assigned by a manufacturer of the drug due to testing. The enterprise organization may distribute the drug such as obtaining the drug from the manufacturer, storing the drug in a DC, and providing the drug to provider facilities such as pharmacies, retail stores, and/or other types of facilities that a user may go to in order to obtain the drug. In some variations, the drugs may become expired (e.g., past the expiration date), and the present application may be used to determine the usability of the expired drug (e.g., the expired pharmaceutical drug).

For instance, the enterprise computing system 108 may include one or more ML-AI models such as spectrometer ML-AI models, SNR ML-AI models, and/or olfactory ML-AI models. In some instances, the ML-AI models may be generic ML-AI models (e.g., untrained ML-AI models). The enterprise computing system 108 may provide the generic ML-AI models to an expired drug usability device (e.g., device 110 and/or 112). The expired drug usability device may train the ML-AI models. In some examples, after training, the enterprise computing system 108 may receive the trained ML-AI models and store the trained ML-AI models.

The enterprise computing system 108 includes one or more computing devices, computing platforms, systems, servers, and/or other apparatuses capable of performing tasks, functions, and/or other actions for the enterprise organization. The enterprise computing system 108 may be implemented using one or more computing platforms, devices, servers, and/or apparatuses. In some variations, the enterprise computing system 108 may be implemented as engines, software functions, and/or applications. In other words, the functionalities of the enterprise computing system 108 may be implemented as software instructions stored in storage (e.g., memory) and executed by one or more processors.

The training facility 102 may be any facility (e.g., building, residence, storefront, structure) that trains the ML-AI models such as the spectrometer ML-AI models, the SNR ML-AI models, and/or the olfactory ML-AI models. For example, the training facility 102 may be a distribution center that obtains the medication/drugs from a manufacturer. The training facility 102 may include one or more computing devices or entities that are configured to train the ML-AI models using samples of the medication. For instance, the training facility 102 may include a first expired drug usability device 110. The first expired drug usability device 110 may include one or more sensors and/or devices such as an olfactory sensor and/or a spectrometer. The first expired drug usability device 110 may obtain training information from the olfactory sensor and/or the spectrometer. Using the training information, the first expired drug usability device 110 may train the ML-AI models, and provide the trained ML-AI models to a second expired drug usability device 112 and/or the enterprise computing system 108. The first expired drug usability device 110 and the training of the ML-AI models will be described in further detail below.

The prescription provider facility 104 may be any building, storefront, structure that distributes medication (e.g., pharmaceutical drugs) to a user. For instance, the enterprise organization may be a health care enterprise organization that distributes medications to a user. For example, a physician or medical provider may provide a prescription (e.g., script) to a user indicating a drug, a dosage of the drug, frequency, and so on. Based on the prescription, the enterprise organization may distribute the drug to the user. The enterprise organization may own, operate, and/or be associated with the training facility 102 and/or the prescription provider facility 104. For instance, the training facility 102 may be a distribution center and the prescription provider facility 104 may be a pharmacy, retail store, and/or other facility that dispenses the drug to the user based on the prescription provided by the physician or medical provider.

The prescription provider facility 104 may include a second expired drug usability device 112. The second expired drug usability device 112 may obtain the trained ML-AI models from the first expired drug usability device 110 and determine the usability of a sample of the drug. For instance, the second expired drug usability device 112 may include one or more sensors/devices such as a spectrometer and/or an olfactory sensor. The second expired drug usability device 112 may obtain drug expiration information for a sample of the drug using the one or more sensors/devices. Based on inputting the drug expiration information into the one or more trained ML-AI models, the second expired drug usability device 112 may determine usability information such as drug potency of the sample of the drug. For instance, the usability information may indicate that the sample of the drug is 90% effective even though the drug is past the indicated expiration date. The second expired drug usability device 112 may provide the usability information to another device such as the enterprise computing system 108 and/or perform other actions.

It will be appreciated that the exemplary environment depicted in FIG. 1 is merely an example, and that the principles discussed herein may also be applicable to other situations—for example, including other types of institutions, organizations, devices, systems, and network configurations. For instance, a single expired drug usability device may perform the functionalities of both the first expired drug usability device 110 and the second expired drug usability device 112. For instance, the single expired drug usability device may train the ML-AI models and use the ML-AI models to determine the usability information.

As will be described herein, the environment 100 may be used by health care enterprise organizations. However, in other instances, the environment 100 may be used by other types of enterprise organizations such as financial institutions or insurance institutions.

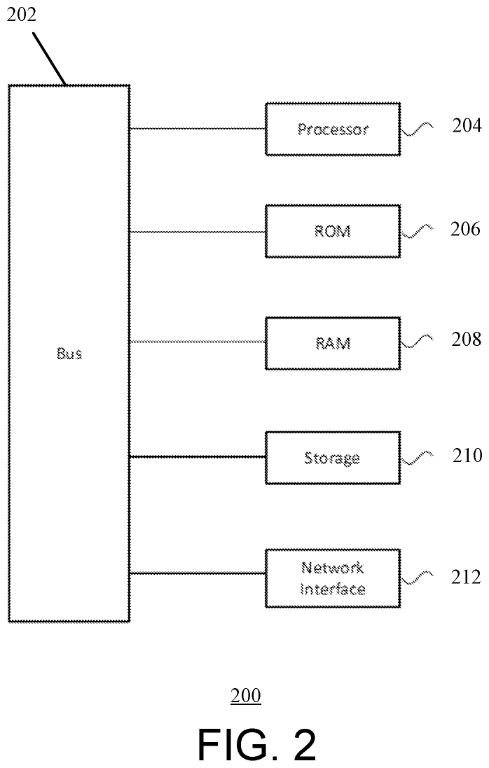

FIG. 2 is a block diagram of an exemplary system and/or device 200 within the environment 100. The device/system 200 includes a processor 204, such as a central processing unit (CPU), controller, and/or logic, that executes computer executable instructions for performing the functions, processes, and/or methods described herein. In some examples, the computer executable instructions are locally stored and accessed from a non-transitory computer readable medium, such as storage 210, which may be a hard drive or flash drive. Read Only Memory (ROM) 206 includes computer executable instructions for initializing the processor 204, while the random-access memory (RAM) 208 is the main memory for loading and processing instructions executed by the processor 204. The network interface 212 may connect to a wired network or cellular network and to a local area network or wide area network, such as the network 106. The device/system 200 may also include a bus 202 that connects the processor 204, ROM 206, RAM 208, storage 210, and/or the network interface 212. The components within the device/system 200 may use the bus 202 to communicate with each other. The components within the device/system 200 are merely exemplary and might not be inclusive of every component within the device/system 200. For example, as will be described below, the first expired drug usability device 110 and the second expired drug usability device 112 may include some of the components within the device/system 200 and may also include further components such as one or more sensors and/or devices. Additionally, and/or alternatively, the device/system 200 may further include components that might not be included within every entity of environment 100.

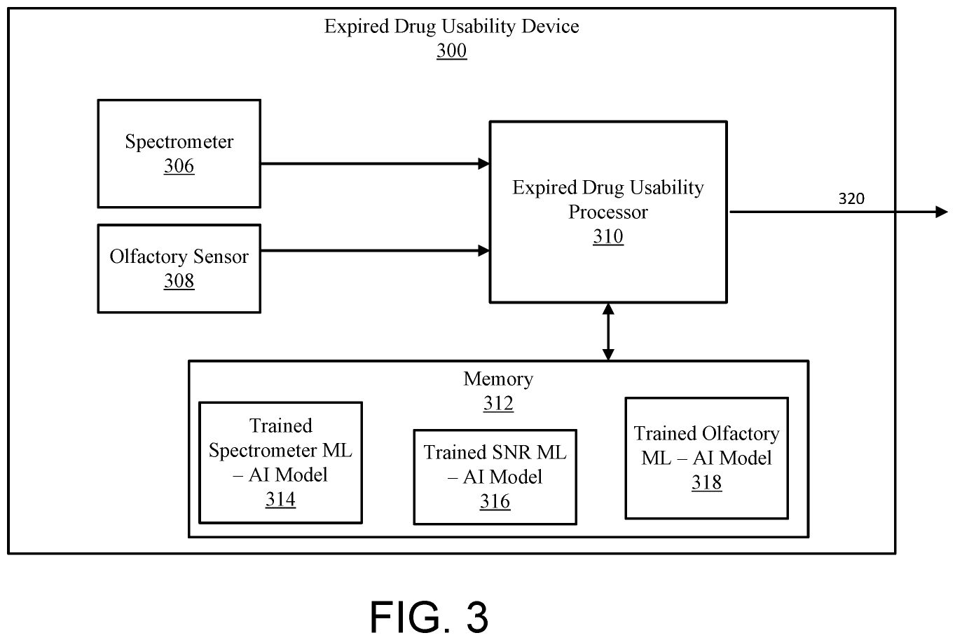

FIG. 3 is a simplified block diagram depicting an exemplary expired drug usability device 300 in accordance with one or more examples of the present application. The expired drug usability device 300 may be the first expired drug usability device 110 and/or the second expired drug usability device 112 that are shown in FIG. 1. The expired drug usability device 300 includes a spectrometer 306 and an olfactory sensor 308. The spectrometer 306 is configured to obtain information (e.g., training information and/or expired drug usability information) associated with a drug or medication. For instance, the spectrometer 306 may be used to separate and measure the spectral components of a physical phenomenon. In some examples, the spectrometer 306 may be an optical spectrometer that measures properties of light over a specific portion of the electromagnetic spectrum.

For example, the pharmaceutical drug may be in a solid form (e.g., a batch or lot of pills or tablets) or in a liquid form. If the pharmaceutical drug is in a solid form, an individual may crush one or more of these pills/tablets to determine the usability of the batch/lot. For instance, the crushed pill or tablet may be a sample of the pharmaceutical drug that is tested by the expired drug usability device 300 to train the ML-AI models and/or to use to determine the drug potency. The spectrometer 306 may shine light on the sample of the pharmaceutical drug such that energy is emitted. The spectrometer 306 may detect the emitted energy, and generate, based on the detection, spectrometer output data such as one or more images indicating characteristics of the emitted energy. The characteristics of the emitted energy are described below. Additionally, and/or alternatively, the spectrometer 306 may perform Raman spectroscopy on the sample of the pharmaceutical drug to obtain the training information and/or drug expiration information. Additionally, and/or alternatively, the spectrometer 306 may be a liquid spectrometer. Additionally, and/or alternatively, the spectrometer 306 may be a near infrared spectrometer (NIR spectrometer).

In some instances, the spectrometer 306 may be a near infrared spectrometer, which is an analytical instrument used to examine pharmaceutical, chemical or medical materials. NIR spectrometers may provide spectral wavelength ranges from around 12,500 to 4000 wavenumbers or reciprocal wavelengths (cm⁻¹) or more. NIR spectrometers may use and/or include high precision diode array detectors and silicon or lead-sulfide charge-coupled devices (CCDs), which are generally more sensitive. NIR spectrometers may be configured to accommodate both liquid and solid samples (e.g., the drug in a liquid form or in a crushed up, solid form), including compatibility with many flow-cell types for assay analysis. The use of near infrared spectrometers may be advantageous given their ease of use, multiple sample capacity, and portability.

In operation, the spectrometer 306 (e.g., a NIR spectrometer) may illuminate the substance (e.g., the pharmaceutical drug to be imaged) with a broad-spectrum of near infrared light (e.g., illuminate the sample using multiple different wavelengths or frequencies), which can be absorbed, transmitted, reflected or scattered by the sample of the pharmaceutical drug. The illumination may be in the wavelength range of 0.8 to 2.5 microns (e.g., 800 to 2500 nanometers (nm)). The spectrometer 306 may use a diffraction grating and/or other types of dispersive elements to allow the intensity, transmittance, and/or other characteristics of the different wavelengths of light to be determined, recorded and/or detected by a detector associated with and/or included within the spectrometer 306.

In some instances, the spectrometer 306 may include a processor (e.g., a processor within the spectrometer 306 and separate from the processor 310) that is configured to generate and provide spectrometer output data. For example, the detector of the spectrometer 306 may detect the characteristics of the resultant light after the light has been illuminated onto the sample. The processor may generate spectrometer output data based on the characteristics. For instance, the spectrometer output data may indicate, be, and/or include one or more images indicating graphical representations of the characteristics of the light. The characteristics of the light may include, but are not limited to, the transmittance or transmission of the light (e.g., a value or percentage of the light that is transmitted through the sample), an absorbance of the light (e.g., a value or percentage of the light that is absorbed by the sample), wavelengths of the light, wavenumbers of the light, a reflectance or scattering of the light, an intensity of the light, RGB values (red, green, blue values) for the intensity and wavelength of the light that is emitted/reflected from the sample, ramen shift values (cm⁻¹), and/or other characteristics of the light. For example, the spectrometer output data (e.g., the training information and/or drug expiration information) may include a graphical representation of the light such as the wavelengths of the light on the x-axis and the absorbance or transmittance of the light on the y-axis (e.g., a graphical representation indicating percentages of the wavelengths of the light that the sample absorbs or transmitted by the sample).

The expired drug usability device 300 further includes an olfactory sensor 308 that is configured to obtain information (e.g., training information and/or expired drug usability information) associated with the drug or medication. For instance, the olfactory sensor 308 may be used to detect smells from the sample of the drug or medication. For example, the olfactory sensor 308 may use an electronic sensor array, preprocessor, and a pattern recognition step to detect the smells from the sample of the pharmaceutical drug. The olfactory sensor 308 (e.g., an electronic nose) is an electronic sensing device configured to detect odors or flavors. The expression “electronic sensing” refers to the capability of reproducing human senses using sensor arrays and pattern recognition systems. The stages or components of the olfactory sensor 308 for recognizing the smells may be similar to human olfaction and are performed for identification, comparison, quantification, and/or other applications, including data storage and retrieval. Some such devices are used for industrial purposes.

In operation, the olfactory sensor 308 may be configured to detect smells from the sample of the drug or medication. Then, similar to the spectrometer 306, the olfactory sensor 308 may include a processor (e.g., a processor within the olfactory sensor 308 and separate from the processor 310) that is configured to generate and provide the olfactory output data. The olfactory output data (e.g., the training information and/or drug expiration information) may indicate, be, and/or include one or more graphical representations of signals (e.g., electrical signals such as voltage measurements or readings) over a period of time (e.g., in seconds (s)). For instance, the graphical representation may be an electrical signal (e.g., voltage measurements) over two minutes, and each unique smell (e.g., each sample) may have a unique electrical signal. In some instances, the processor of the olfactory sensor 308 may use a short term Fourier transform (STFT) to determine the olfactory output data and/or generate the graphical representation. For instance, the olfactory sensor 308 may obtain time wave data, and the processor may use STFT to transform the obtained time wave data into the olfactory output data (e.g., the graphical representation).

The expired drug usability device 300 also includes expired drug usability processor(s) 310. The processor 310 may be any type of hardware and/or software logic, such as a central processing unit (CPU), RASPBERRY PI processor/logic, controller, and/or logic, that executes computer executable instructions for performing the functions, processes, and/or methods described herein. For example, the processor(s) 310 may receive information from the spectrometer 306 and/or the olfactory sensor 308. For instance, the processor 310 may receive spectrometer output data from the spectrometer 306 and olfactory output data from the olfactory sensor 308. In some instances, the spectrometer 306 and the olfactory sensor 308 may include separate processors that are configured to generate the spectrometer and olfactory output data. In other instances, the processor 310 may be configured to generate the spectrometer and olfactory output data (e.g., the graphical representations indicating the training information and/or drug expiration information).

The processor 310 may use the spectrometer output data for training a spectrometer ML-AI model. For instance, the expired drug usability device 300 may obtain an untrained spectrometer ML-AI model from the enterprise computing system 108. The processor 310 may obtain spectrometer training information from the spectrometer 306. For example, the spectrometer 306 may obtain spectrometer training information at different times during the life expectancy of the pharmaceutical drug, and provide the spectrometer training information to the processor 310. For instance, the drug potency (e.g., a measure of drug activity expressed in terms of the amount required to produce an effect of given intensity) of the pharmaceutical drug may decrease over time. As mentioned previously, initially, the drug potency may be at 100%, but may decrease over the life expectancy of the pharmaceutical drug. For instance, between a first time instance when the drug is received at the training facility 102 (e.g., distribution center) and a second time instance associated with the expiration date of the drug, the drug potency may remain at 100% or remain at a substantially significant amount (e.g., 95%). After the expiration date of the drug, the drug potency may continuously decrease and/or decrease more rapidly. As such, the expired drug usability device 300 may obtain samples of the drug at different instances within the life expectancy of the drug such as at a time prior to the expiration date of the pharmaceutical drug (e.g., when the training facility 102 obtains the drug from the manufacturer), at the expiration date of the pharmaceutical drug, and at one or more times after the expiration date of the pharmaceutical drug (e.g., three months, six months, nine months, and/or a year after the expiration date of the pharmaceutical drug).

In some instances, a batch or lot of the drug may be received at the training facility 102. A sample of the drug may be tested by the expired drug usability device 300 (e.g., the first expired drug usability device 110 of FIG. 1) when the batch or lot is received at the training facility 102. The expired drug usability device 300 may obtain a plurality of first spectrometer output data (e.g., one hundred or more spectrograph images for the sample of the drug) for when the drug arrives at the training facility 102. Then, at the indicated expiration date of the drug, another sample of the drug may be tested by the expired drug usability device 300. The expired drug usability device 300 may obtain a plurality of second spectrometer output data (e.g., another hundred or more spectrograph images for the second sample of the drug) at the expiration date of the drug. Furthermore, after the expiration date of the drug (e.g., six months or one year after the expiration date), the expired drug usability device 300 may obtain a plurality of third spectrometer output data (e.g., yet another hundred or more spectrograph images for the third sample of the drug) after the expiration date of the drug. For instance, the expired drug usability device 300 may obtain spectrometer output data (e.g., one hundred images) at six months after the expiration date for the drug, and may obtain additional spectrometer output data (e.g., another hundred images) a year after the expiration date for the drug. The processor 310 may use the spectrometer output data (e.g., the spectrometer training information such as the graphical representations indicating the characteristics of the light after hitting the sample) at the different instances within the life expectancy of the pharmaceutical drug (e.g., the first spectrometer output data when the drug arrives at the training facility 102, the second spectrometer output data at the expiration date of the drug, the third spectrometer output data after the expiration date of the drug such as six months and a year after the expiration date of the drug) to train the spectrometer ML-AI model.

In some instances, to train the spectrometer ML-AI model, the processor 310 may prepare the data (e.g., standardize it) and/or otherwise re-format the data such that it is able to be used to train the spectrometer ML-AI model. The processor 310 may split the data (e.g., the spectrometer output data) into training data and test data. Then, the processor 310 may train the spectrometer ML-AI model using the training data to reach a target. For example, the processor 310 may train the spectrometer ML-AI model by determining whether the training data is continuous or discrete and/or using one or more regression/classification algorithms. After training the spectrometer ML-AI model, the processor 310 may test the trained model using the test data. The processor 310 may perform another continuous or discrete analysis and render a decision. Finally, after the spectrometer ML-AI model is trained, the processor 310 may provide the trained spectrometer ML-AI model to another expired drug usability device 300 (e.g., the second expired drug usability device 112 shown in FIG. 1) and/or use the trained spectrometer ML-AI model to determine the usability of the drug.

In some instances, the spectrometer ML-AI model may be a computer vision model (e.g., a deep learning model and/or a convolutional neural network (CNN)). The spectrometer ML-AI model may take as input digital images (e.g., the graphical representations of spectrometer output data such as graphs indicating the absorbance of the light from the sample on the y-axis and the wavelengths on the x-axis) and provide meaningful decisions based on that information. For example, during the training process, the processor 310 may obtain training information, which may comprise spectrometer output data from the spectrometer 306 at different instances within the life expectancy of the drug. For instance, the training information may include graphical representations (e.g., images of graphs) from the spectrometer 306 such as graphs indicating the transmission and/or absorbance of the light at different wavelengths or wavenumbers (e.g., one hundred images each of the absorbance of the light compared to the wavelength at the time the drug arrived at the training facility 102, at the expiration date, six months after the expiration date, and a year after the expiration date). The processor 310 may input the graphical representations into the spectrometer ML-AI model (e.g., the computer vision model) to train the computer vision model.

Additionally, and/or alternatively, the processor 310 may train an olfactory ML-AI model using the olfactory output data. For instance, the expired drug usability device 300 may obtain an untrained olfactory ML-AI model from the enterprise computing system 108. The processor 310 may obtain olfactory training information from the olfactory sensor 308. For example, the olfactory sensor 308 may obtain olfactory training information at different times during the life expectancy of the pharmaceutical drug, and provide the olfactory training information to the processor 310. For instance, in some variations, at each instance that the expired drug usability device 300 obtains spectrometer output data, the expired drug usability device 300 may further obtain olfactory output data from the olfactory sensor 308. For example, the processor 310 may obtain first olfactory output data when the drug arrives at the training facility 102, second olfactory output data at the expiration date of the drug, and/or third olfactory output data after the expiration date of the drug such as six months and a year after the expiration date of the drug. Using the olfactory output data, the processor 310 may train the olfactory ML-AI model.

In some instances, to train the olfactory ML-AI model, the processor 310 may prepare the data (e.g., standardize it) and/or otherwise re-format the data such that it is able to be used to train the olfactory ML-AI model. The processor 310 may split the data (e.g., the olfactory output data) into training data and test data. Then, the processor 310 may train the olfactory ML-AI model using the training data to reach a target. For example, the processor 310 may train the olfactory ML-AI model by determining whether the training data is continuous or discrete and/or using one or more regression/classification algorithms. After training the olfactory ML-AI model, the processor 310 may test the trained model using the test data. The processor 310 may perform another continuous or discrete analysis and render a decision. Finally, after the olfactory ML-AI model is trained, the processor 310 may provide the trained olfactory ML-AI model to another expired drug usability device 300 (e.g., the second expired drug usability device 112 shown in FIG. 1) and/or use the trained olfactory ML-AI model to determine the usability of the drug.

In other words, in some examples, the olfactory ML-AI model may be another computer vision model (e.g., a deep learning model and/or a convolutional neural network (CNN)) that is separate from the spectrometer computer vision model. The olfactory ML-AI model may take as input digital images (e.g., the graphical representations of olfactory output data such as graphs indicating the voltage measurements over a period time that is detected by an olfactory sensor 308) and provide meaningful decisions based on that information. For example, during the training process, the processor 310 may obtain training information, which may comprise olfactory output data from the olfactory sensor 308 at different instances within the life expectancy of the drug. The processor 310 may input the graphical representations into the olfactory ML-AI model (e.g., the computer vision model) to train the computer vision model.

Additionally, and/or alternatively, the processor 310 may train a signal-to-noise ratio (SNR) ML-AI model using SNR ML-AI training information. For instance, the processor 310 may determine the SNR ML-AI training information based on the spectrometer training information. For instance, as mentioned above, the spectrometer training information may indicate the absorbance/transmittance of the light at different wavelengths after the light is illuminated onto the sample. The processor 310 may use one or more equations or algorithms to determine the SNR ML-AI training information using the spectrometer training information. For example, the processor 310 may determine a mean square error (MSE) and/or a peak SNR (PSNR) that shows a ratio between a maximum possible power of a signal and a power of the same image with noise, which may be expressed in a logarithmic decibel scale.

In some examples, the processor 310 may use an average signal value and a standard deviation of the signal to determine the SNR. For instance, the processor 310 may use the below equation to determine the SNR:

$$S N R = \frac{{μ}_{s i g}}{{σ}_{s i g}}$$

where μ_{sig} indicates the ratio of the average signal value and σ_{sig} indicates the standard deviation of the signal to determine the SNR.

In other examples, the processor 310 may use an SNR for a CCD image capturing device (e.g., a CCD camera) associated with or included within the spectrometer 306. For instance, the SNR for the CCD camera may be determined using the below equation:

$$S N R = \frac{IQEt}{\sqrt{IQEt + N d t + N {r}^{2}}}$$

where I is the photon flux (photons/pixel/second), QE is the quantum efficiency, t is the integration time (seconds), Nd is the dark current (electrons/pixel/second), and Nr is the read noise (electrons).

The processor 310 may use the one or more equations (e.g., the equations above and/or other equations) to determine the SNR. The SNR may be any function (e.g., equation and/or algorithm) that is associated with the computer vision models such as the olfactory ML-AI model and/or the spectrometer ML-AI model, and may be used to determine the accuracy of the image (e.g., the graphical representation indicated by the spectrometer output data and/or the spectrometer ML-AI training information). In some instances, the SNR may describe the quality of the measurement associated with the graphical representation. For instance, in CCD imaging, SNR may refer to the relative magnitude of the signal compared to the uncertainty in that signal on a per-pixel basis. In other words, the SNR may be the ratio of the measured signal to the overall measured noise (frame-to-frame) at that pixel.

Based on the equations, the processor 310 may generate the SNR ML-AI training information, which may be, include, and/or indicate graphical representations of the SNR. For instance, using the SNR function with the spectrometer output data, the processor 310 may generate the graphical representation of the SNR. For instance, the processor 310 may generate a graphical representation indicating the μ_{sig} and σ_{sig} of the distance of the pixels within the spectrometer output data along with the intensity (e.g., the intensity measured as an arbitrary unit (AU)). In other words, the processor 310 may use a function that is part of the computer vision model (e.g., the spectrometer computer vision model). Using the function, the processor 310 may generate the graphical representation of the SNR. Additionally, and/or alternatively, the processor 310 may determine a value (e.g., a number) based on the SNR. The processor 310 may use the value of the SNR to determine the drug potency.

After obtaining the SNR ML-AI training information, the processor 310 may train the SNR ML-AI model. For example, to train the SNR ML-AI model, the processor 310 may prepare the data (e.g., standardize it) and/or otherwise re-format the data such that it is able to be used to train the SNR ML-AI model. The processor 310 may split the data (e.g., the SNR training information) into training data and test data. Then, the processor 310 may train the SNR ML-AI model using the training data to reach a target. For example, the processor 310 may train the SNR ML-AI model by determining whether the training data is continuous or discrete and/or using one or more regression/classification algorithms. After training the SNR ML-AI model, the processor 310 may test the trained model using the test data. The processor 310 may perform another continuous or discrete analysis and render a decision. Finally, after the SNR ML-AI model is trained, the processor 310 may provide the trained SNR ML-AI model to another expired drug usability device 300 (e.g., the second expired drug usability device 112 shown in FIG. 1) and/or use the trained SNR ML-AI model to determine the usability of the drug.

In some variations, the SNR ML-AI model may be yet another computer vision model (e.g., a deep learning model and/or a convolutional neural network (CNN)). The SNR ML-AI model may take as input digital images (e.g., the graphical representations of the SNR determined using one or more functions and the spectrometer output data) and provide meaningful decisions based on that information.

The spectrometer ML-AI model, the olfactory ML-AI model, and the SNR ML-AI model may be any type of ML-AI model (e.g., supervised ML-AI models, unsupervised ML-AI models, and/or deep learning models). For example, as mentioned above, the spectrometer ML-AI model, the olfactory ML-AI model, and the SNR ML-AI model may be computer vision models (e.g., deep learning and/or CNN).

After training the ML-AI models, the processor 310 may provide information 320 including the spectrometer ML-AI model, the olfactory ML-AI model, and the SNR ML-AI model to another entity such as another expired drug usability device (e.g., the expired drug usability device 112).

Additionally, and/or alternatively, the expired drug usability processor 310 may store the trained ML-AI models into memory 312. For instance, the memory 312 may include the trained spectrometer ML-AI model 314, the trained SNR ML-AI model 316, and the trained olfactory ML-AI model 318. In some examples, the memory 312 may be and/or include a computer-usable or computer-readable medium such as, but not limited to, an electronic, magnetic, optical, electromagnetic, infrared, or semiconductor computer-readable medium. More specific examples (e.g., a non-exhaustive list) of the computer-readable medium may include the following: an electrical connection having one or more wires; a tangible medium such as a portable computer diskette, a hard disk, a time-dependent access memory (RAM such as the RAM 208), a ROM such as ROM 206, an erasable programmable read-only memory (EPROM or Flash memory), a compact disc read-only memory (CD ROM), or other tangible optical or magnetic storage device. The computer-readable medium may store computer-readable instructions/program code for carrying out operations of the present application. For example, when executed by the processor 310, the computer-readable instructions/program code may carry out operations described herein.

In some variations, as mentioned above, the same expired drug usability device 300 that trained the ML-AI models may further use the ML-AI models to determine the usability for the drug. For example, after training the ML-AI models and storing them in memory 312, the processor 310 may obtain new data from the spectrometer 306 and the olfactory sensor 308. For instance, after expiration of the pharmaceutical drug, the enterprise organization may seek to process the pharmaceutical drug and provide the drug to the user as the drug may continue to be usable even after the expiration date. As such, the expired drug usability device 300 may determine usability information such as a usability confidence value (e.g., percentage and/or numerical value) of the drug based on additional information from the spectrometer 306 and/or the olfactory sensor 308.

For example, an individual may obtain another sample of the drug (e.g., crush one or more pills or tablets). The sample of the drug may be past the expiration date indicated by the manufacturer. The expired drug usability device 300 may test the sample of the drug to determine the usability information (e.g., the usability confidence value). For instance, the expired drug usability device 300 may use the spectrometer 306 and/or the olfactory sensor 308 to obtain information for the sample of the drug. For instance, the processor 310 may obtain drug expiration information of the sample such as spectrometer data from the spectrometer 306 and/or olfactory data from the olfactory sensor 308. The spectrometer data from the spectrometer 306 may indicate characteristics of the light (e.g., the transmittance or transmission of the light, an absorbance of the light, wavelengths of the light, wavenumbers of the light, a reflectance or scattering of the light, an intensity of the light, RGB values for the intensity and wavelength of the light that is emitted/reflected from the sample, ramen shift values, and/or other characteristics of the light). The olfactory data from the olfactory sensor 308 may indicate electrical signals over a period of time based on the detection of the smell from the sample. Then, the processor 310 may retrieve one or more trained ML-AI models from the memory 312 such as the trained spectrometer ML-AI model 314, the trained SNR ML-AI model 316, and/or the trained olfactory ML-AI model 318. Then, the processor 310 may input the drug expiration information into the one or more trained ML-AI models, and the trained ML-AI models may output usability information for the sample of the drug. For instance, the processor 310 may input the spectrometer data into the trained spectrometer ML-AI model 314 to determine spectrometer usability information. The spectrometer usability information may include an indication of drug potency such as a spectrometer usability confidence value (e.g., 96%). The processor 310 may input the olfactory data into the trained olfactory ML-AI model 318 to determine olfactory usability information (e.g., an olfactory usability confidence value such as 91%). Additionally, and/or alternatively, the processor 310 may determine the SNR data based on the spectrometer data as described above. Then, the processor 310 may input the SNR data into the trained SNR ML-AI model 316 to determine the SNR usability information (e.g., an SNR usability confidence value such as 93%). The processor 310 may determine the usability of the drug (e.g., the usability information of the drug) based on the spectrometer usability information, the olfactory usability information, and/or the SNR usability information. For instance, the processor 310 may determine an average (e.g., a weighted average) of the usability information (e.g., an average of 96%, 93%, and 91%). For example, the average may be 93.333%, and the processor 310 may determine the usability of the drug based on the average (e.g., 93.333%). Then, the processor 310 may provide the information 320 (e.g., the usability information) to another entity such as a computing device within the prescription provider facility 104 and/or the enterprise computing system 108.

In some instances, as mentioned above, the ML-AI models 314, 316, and/or 318 may be computer vision models. Accordingly, the processor 310 may input the graphical representations of the sample into the ML-AI models 314, 316, and/or 318 to determine the usability confidence values. For instance, the spectrometer data from the spectrometer 306 may indicate one or more graphical representations of the absorbance over the wavelength of the light for the sample. The processor 310 may input the graphical representations into the trained spectrometer ML-AI model 314, and the trained spectrometer ML-AI model 314 may output a spectrometer usability confidence value (e.g., 96%) indicating the drug potency of the sample of the drug. Similarly, the processor 310 may input the graphical representation of the olfactory data (e.g., a voltage signal over a period of time indicating the smell of the sample of the drug) into the olfactory ML-AI model 318, and the olfactory ML-AI model 318 may output the olfactory usability confidence value (e.g., 91%). Further, the processor 310 may input the graphical representation of the SNR data into the trained SNR ML-AI model 316 to determine the SNR usability confidence value (e.g., 93%).

Additionally, and/or alternatively, the processor 310 and/or the other computing entity may perform one or more actions based on the usability information. For instance, the processor 310 may compare the usability of the drug (e.g., 93.333%) with one or more thresholds. Based on the one or more thresholds, the processor 310 may provide information 320 indicating the usability of the drug. For example, based on the usability of the drug being above 80%, the processor 310 may provide information 320 indicating that the drug is usable and/or provide a time frame for using the drug. The processor 310 may provide the information 320 to another computing entity at the prescription provider facility 104 (e.g., the pharmacy), and the computing entity may display the usability information. For instance, the pharmacy computing device may display that the drug is still usable based on the testing of the sample. Based on the usability of the drug being below one or more thresholds, the processor 310 may provide information 320 indicating that the drug is not usable anymore. The usability information may include any information indicating whether the drug is still usable even past the expiration date of the drug. For instance, the usability information may indicate a feasibility or efficacy of the drug as well as how the drug would work when consumed by the user (e.g., 80 or 90% effective). In some examples, the usability information may indicate a percentage of usability from the ML-AI models that was pre-made for baselines. For example, based on the olfactory and spectrometer ML-AI models, the processor 310 may determine that at six months past the expiration date of the drug, the drug has a usability confidence value of 80% and a confidence score of 95%. In other words, based on the output from the ML-AI models (e.g., the spectrometer ML-AI model, the olfactory ML-AI model, and/or the SNR ML-AI model), the processor 310 may determine usability information (e.g., that the sample has an 80% potency based on the average of the usability confidence values from the output from the ML-AI models). Furthermore, the processor 310 may determine a confidence score (e.g., 95%) associated with the usability confidence values. The confidence score may indicate a confidence that the potency or the usability confidence value (e.g., 80%) is accurate.

Additionally, and/or alternatively, the information 320 may indicate to provide alternative uses for the drug. For instance, based on the usability of the drug being below one or more thresholds, the processor 310 may provide information 320 indicating that the drug may be used for pets rather than for humans. Additionally, and/or alternatively, the information 320 may indicate to change the prescriptions for the user based on the usability information. For instance, the information 320 may indicate to change the prescription for the user such that the same active chemical amount of the drug is still taken by the user (e.g., take 2 or 3 tablets rather than 1 tablet of the drug given the drug potency indicated by the ML-AI models). Additionally, and/or alternatively, the information 320 may indicate to sell the drugs at a discount and/or at cost. Additionally, and/or alternatively, the information 320 may indicate to donate the drugs to people who may need it and/or for the drug to be stockpiled for later use and/or emergency use. For example, the present application may be used in connection with the Shelf Life Extension Program (SLEP). Additionally, and/or alternatively, the pharmaceutical drug may be split into its individual compounds (e.g., chemical compounds) that can then be used to create new drugs. Certain chemical compounds may have a longer life expectancy than other compounds. Therefore, the information 320 may indicate the usability of certain chemical compounds that may be used to create new drugs.

The expired drug usability device 300 may be used to train one or more ML-AI models (e.g., the models 314, 316, and/or 318). Additionally, and/or alternatively, the expired drug usability device 300 may determine whether the sample of the drug (e.g., pharmaceutical drug/medication) is still usable after the expiration date of the drug. The expired drug usability device 300 may use one or more ML-AI models (e.g., models 314, 316, and/or 318) and drug expiration information (e.g., spectrometer data from the spectrometer 306 and/or the olfactory data from the olfactory sensor 308) to determine the usability of the drug (e.g., the usability information). The drug usability device 300 may provide information 320 indicating the usability of the drug to another entity.

Additionally, and/or alternatively, two separate expired drug usability devices 300 may be used to train and determine the usability information. For instance, referring to FIG. 1, the first expired drug usability device 110 may be used to train the ML-AI models. Then, the first expired drug usability device 110 may provide the trained ML-AI models (e.g., information 320) to a second expired drug usability device 112. The second expired drug usability device 112 may determine the usability information of a sample of the drug.

In some variations, the training facility 102 may be a distribution center that receives batches/lots of the pharmaceutical drug. The training facility 102 includes the first expired drug usability device 110, and the first expired drug usability device 110 may perform the training of the ML-AI models. After training the ML-AI models, the first expired drug usability device 110 may provide the trained ML-AI models to a second expired drug usability device 112, which is at a prescription provider facility 104 (e.g., a pharmacy). For example, the distribution center may distribute the drug to a plurality of local pharmacies in the surrounding area. The pharmacies may hold the drug and in some instances, may hold the drug even past the expiration date of the drug. After the expiration date (e.g., a month after the expiration date or ten months after the expiration date), the pharmacies may seek to test the drug to determine whether the drug is still usable. The pharmacy includes a second expired drug usability device 112. Further, a sample of the drug that is past the expiration date may be obtained. The second expired drug usability device 112 may obtain spectrometer data and/or olfactory sensor data of the sample of the drug that is past the expiration date. Then, based on the ML-AI models, the second expired drug usability device 112 may determine the usability information and/or other information based on using the ML-AI models. For instance, the expired drug usability device 112 may determine usability information indicating a usability confidence value (e.g., an average of the three outputs from the ML-AI models). Based on the usability confidence value, the expired drug usability device 112 may perform one or more actions such as displaying on a computing entity of the pharmacy whether the drug is still usable. Therefore, by determining the usability of the sample, the rest of the batch/lot of the pharmaceutical drug may be usable by the pharmacy even though the batch/lot of the drug is past the indicated expiration date.

In some instances, the expired drug usability device 300 may train different ML-AI models for each type of the pharmaceutical drug and/or for each batch of the pharmaceutical drug. For instance, the expired drug usability device 300 may train a spectrometer ML-AI model for a first type of drug (e.g., ATROVASTATIN) and another spectrometer ML-AI model for another type of drug (e.g., AMOXICILLIN). The expired drug usability device 300 may further train additional ML-AI models (e.g., SNR ML-AI models and/or olfactory ML-AI models) for the different types of drugs. For example, each type of drug may decay in usability at different rates. Accordingly, the expired drug usability device 300 may train and use different ML-AI models for each of the different types of drugs. Additionally, and/or alternatively, the expired drug usability device 300 may train and use different ML-AI models for different batches, lots, dosage amounts (e.g., 10 mg or 30 mg), or manufacturers for the drugs. In some examples, the expired drug usability device 300 may train and/or use one or more ML-AI models (e.g., spectrometer and/or olfactory ML-AI models) to determine whether the drug is toxic and should not be used so as to prevent people from becoming ill. For example, toxic drugs may have distinct spectrometer and/or olfactory information. The expired drug usability device 300 may train the ML-AI models so as to have a baseline ML-AI model(s) for the drugs that become toxic after their expiration date. The expired drug usability device 300 may then use the baseline ML-AI model(s) to determine whether a sample of the drug is toxic.

The expired drug usability device 300 is merely exemplary and the expired drug usability device 300 may include additional or alternative devices, components, and/or sensors as well as perform additional or alternative functions or processes. For instance, the spectrometer 306 and/or the olfactory sensor 308 may be separate from the processor 310 and/or the memory 312. For instance, the spectrometer 306 and/or the olfactory sensor 308 may be electrically connected to the processor 310. Additionally, and/or alternatively, the processor 310 may use one or more wireless communication protocols (e.g., BLUETOOTH and/or WI-FI) to communicate with the spectrometer 306 and/or the olfactory sensor 308. Additionally, and/or alternatively, the processor 310 may use the network 106 to communicate with the spectrometer 306 and/or the olfactory sensor 308.

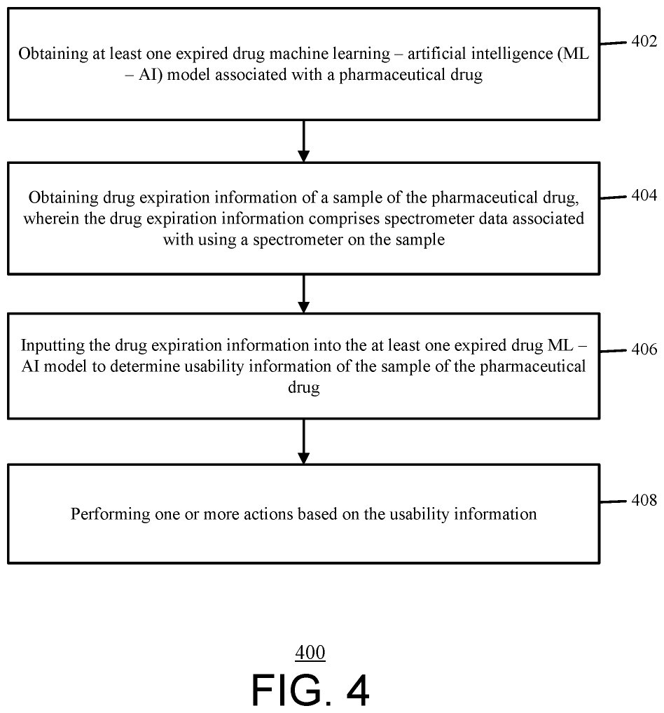

FIG. 4 is an exemplary process 400 for using the expired drug usability device to determine usability of a drug in accordance with one or more examples of the present application. The process 400 may be performed by the expired drug usability device 110, 112, and/or 300 shown in FIGS. 1 and 3. However, it will be recognized that any of the following blocks may be performed in any suitable order and that the process 400 may be performed in any suitable environment. The descriptions, illustrations, and processes of FIG. 4 are merely exemplary and the process 400 may use other descriptions, illustrations, and processes for using an expired drug usability device.

At block 402, the expired drug usability device (e.g., the expired drug usability device 112 or 300) obtains at least one expired drug ML-AI model associated with a pharmaceutical drug. For instance, after training an ML-AI model such as the spectrometer ML-AI model, the expired drug usability device may obtain the trained ML-AI model (e.g., receive the trained ML-AI model another expired drug usability device 110 and/or retrieve the trained ML-AI model from memory). For example, as mentioned previously, an individual may obtain a sample of the pharmaceutical drug and the expired drug usability device may obtain a ML-AI model that is used to determine the usability of the sample of the pharmaceutical drug.

At block 404, the expired drug usability device obtains drug expiration information of a sample of the pharmaceutical drug. The drug expiration information comprises spectrometer data associated with using a spectrometer on the sample (e.g., spectrometer data indicating a graphical representation of the sample such as an absorbance or transmittance percentage over a plurality of wavelengths for the sample). For instance, the expired drug usability device may include a spectrometer and obtain spectrometer output data of the sample of the pharmaceutical drug. The drug expiration information may include the spectrometer output data and/or other data (e.g., SNR data and/or olfactory output data).

At block 406, the expired drug usability device inputs the drug expiration information (e.g., the spectrometer output data) into the at least one expired drug ML-AI model (e.g., the trained spectrometer ML-AI model) to determine usability information of the sample of the pharmaceutical drug. For instance, as mentioned above, the expired drug usability device may obtain a usability confidence value (e.g., 96%) for the sample of the drug.

At block 408, the expired drug usability device performs one or more actions based on the usability information. For instance, the expired drug usability device may provide the usability information to another computing entity such as a computing entity at a pharmacy. The computing entity may display information associated with the usability information such as whether the drug is usable by a user. Additionally, and/or alternatively, the expired drug usability device may compare the confidence value indicated by the usability information with one or more thresholds. Then, the expired drug usability device may provide information indicating the comparison to another computing entity. Additionally, and/or alternatively, the expired drug usability device may include and/or be connected to a display, and may display information such as the usability information on the display.

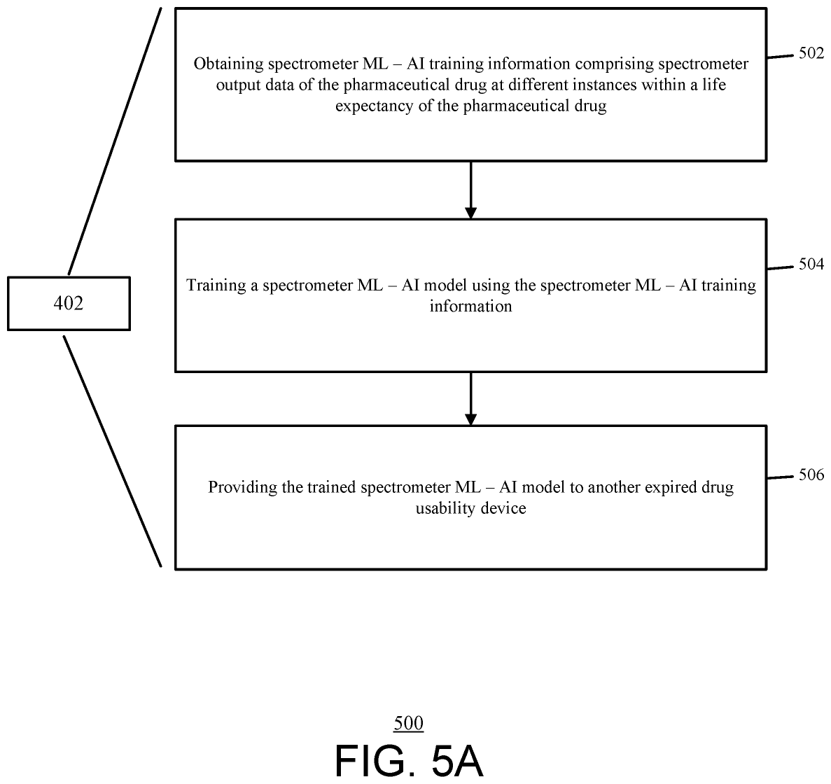

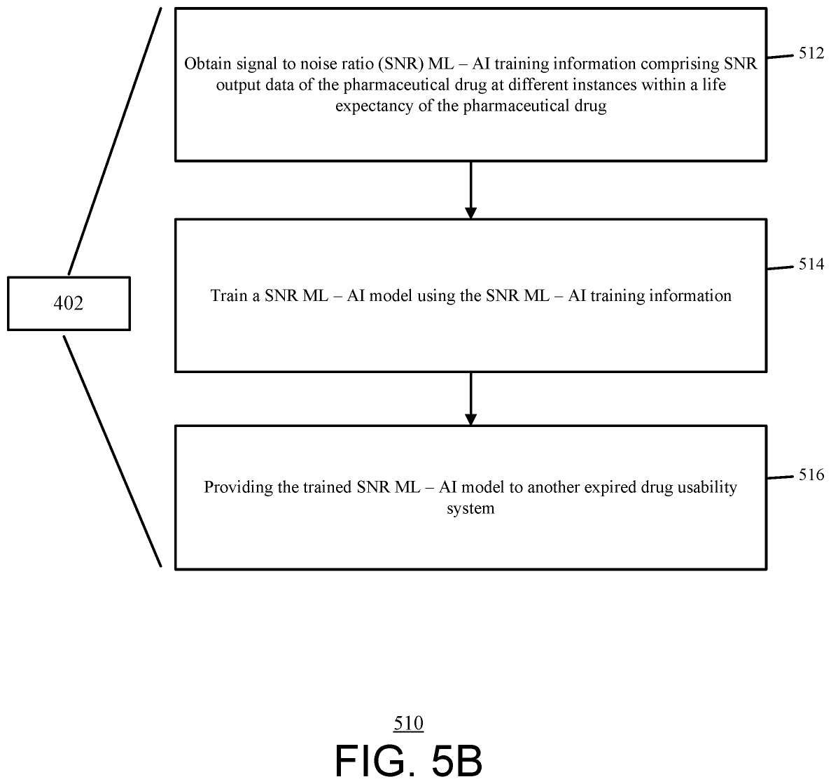

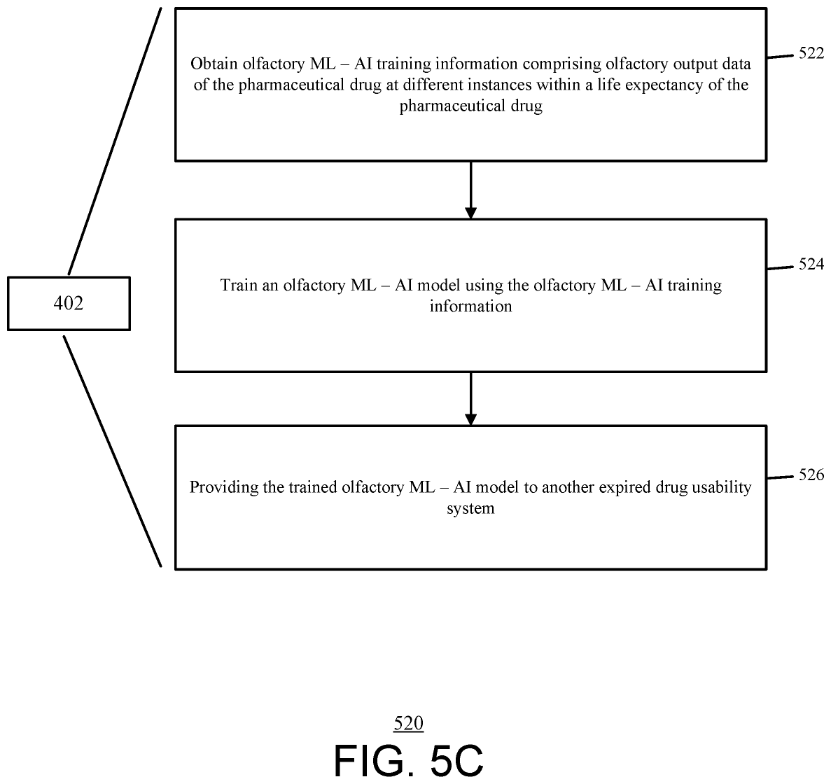

In some instances, the expired drug usability device may train the one or more ML-AI models. Additionally, and/or alternatively, as mentioned above, another expired drug usability device may train the one or more ML-AI models and then provide the trained ML-AI models to the expired drug usability device. FIGS. 5A-5C describe the training of the ML-AI models in more detail, and in particular, block 402 of FIG. 4 in more detail. For instance, FIGS. 5A-5C are exemplary processes for using the expired drug usability device to determine usability of the drug in accordance with one or more examples of the present application. The processes shown in FIGS. 5A-5C may be performed by the expired drug usability device 110, 112, and/or 300 shown in FIGS. 1 and 3. However, it will be recognized that any of the following blocks may be performed in any suitable order and that the processes may be performed in any suitable environment. The descriptions, illustrations, and processes of FIGS. 5A-5C are merely exemplary and the processes may use other descriptions, illustrations, and processes for using an expired drug usability device.

Referring to FIG. 5A, process 500 shows a more detailed version of block 402 of FIG. 4. For instance, at block 502, the expired drug usability device (e.g., the expired drug usability device 110 and/or 300) obtains spectrometer ML-AI training information comprising spectrometer output data of the pharmaceutical drug at different instances within a life expectancy of the pharmaceutical drug. For example, as mentioned above, different samples of the pharmaceutical drug may be obtained at different instances within the life expectancy of the drug such as when the drug arrives at a distribution center (e.g., the training facility 102), the expiration date of the drug, and one or more time periods after the expiration date of the drug (e.g., six months and a year after the expiration date). The expired drug usability device may obtain spectrometer ML-AI training information for each of the samples of the drug (e.g., first spectrometer ML-AI training information for when the drug arrives at the distribution center, second spectrometer ML-AI training information for the expiration date of the drug, and third spectrometer ML-AI training information for after the expiration date of the drug).

At block 504, the expired drug usability device trains a spectrometer ML-AI model using the spectrometer ML-AI training information. For instance, as mentioned above, using the spectrometer ML-AI training information, the expired drug usability device may train a spectrometer ML-AI model.

At block 506, the expired drug usability device provides the trained spectrometer ML-AI model to another expired drug usability device. For instance, as mentioned above, the training of the spectrometer ML-AI model may be performed by a first expired drug usability device (e.g., device 110). After training, the first expired drug usability device 110 may provide the trained spectrometer ML-AI model to a second expired drug usability device 112.

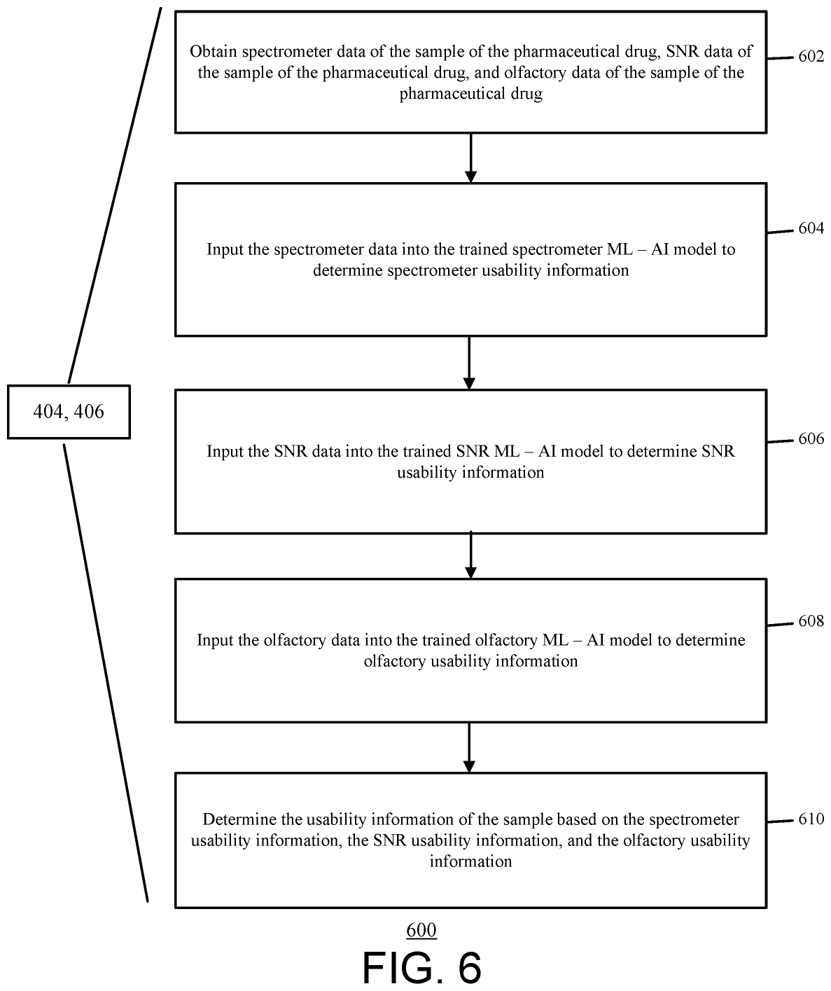

Additionally, and/or alternatively, the expired drug usability device may use multiple ML-AI models to determine the usability of the drug. For instance, as mentioned above, the expired drug usability device may use the SNR ML-AI model and/or the olfactory ML-AI model to determine the usability of the drug. FIGS. 5B, 5C, and 6 show processes that use multiple ML-AI models (e.g., a multi-model ML-AI algorithm) to determine the usability of drug.

For instance, FIG. 5B shows process 510, which may be used in addition to or as an alternative to process 500 shown in FIG. 5A. At block 512, the expired drug usability device obtains SNR ML-AI training information comprising SNR output data of the pharmaceutical drug at different instances within a life expectancy of the pharmaceutical drug. For instance, as mentioned above, the expired drug usability device may determine the SNR ML-AI training information based on the spectrometer output data.

At block 514, the expired drug usability device trains a SNR ML-AI model using the SNR ML-AI training information. At block 516, the expired drug usability device provides the trained SNR ML-AI model to another expired drug usability system.

FIG. 5C shows process 520, which may be used in addition to or as an alternative to process 500 and/or 510 shown in FIGS. 5A and 5B. At block 522, the expired drug usability device obtains olfactory ML-AI training information comprising olfactory output data of the pharmaceutical drug at different instances within a life expectancy of the pharmaceutical drug. At block 524, the expired drug usability device trains an olfactory ML-AI model using the olfactory ML-AI training information. At block 526, the expired drug usability device provides the trained olfactory ML-AI model to another expired drug usability system.

FIG. 6 is another exemplary process for using the expired drug usability device to determine usability of a drug in accordance with one or more examples of the present application. For instance, in some variations, the expired drug usability device may use multiple ML-AI models to determine the usability of the drug. FIG. 6 describes the use of the multiple ML-AI models in more detail, and in particular, blocks 404 and 406 of FIG. 4 in more detail. The process 600 may be performed by the expired drug usability device 110, 112, and/or 300 shown in FIGS. 1 and 3. However, it will be recognized that any of the following blocks may be performed in any suitable order and that the process may be performed in any suitable environment. The descriptions, illustrations, and processes of FIG. 6 are merely exemplary and the process may use other descriptions, illustrations, and processes for using an expired drug usability device.

At block 602, the expired drug usability device (e.g., device 112 and/or 300) obtains spectrometer data of the sample of the pharmaceutical drug, SNR data of the sample of the pharmaceutical drug, and olfactory data of the sample of the pharmaceutical drug. At block 604, the expired drug usability device inputs the spectrometer data into the trained spectrometer ML-AI model to determine spectrometer usability information. At block 606, the expired drug usability device inputs the SNR data into the trained SNR ML-AI model to determine SNR usability information. At block 608, the expired drug usability device inputs the olfactory data into the trained olfactory ML-AI model to determine olfactory usability information. At block 610, the expired drug usability device determines the usability information (e.g., an average of the usability confidence values indicated by the SNR usability information, the spectrometer usability information, and/or the olfactory usability information) of the sample based on the spectrometer usability information, the SNR usability information, and the olfactory usability information.

A number of implementations have been described. Nevertheless, it will be understood that additional modifications may be made without departing from the scope of the inventive concepts described herein, and, accordingly, other examples are within the scope of the following claims. For example, it will be appreciated that the examples of the application described herein are merely exemplary. Variations of these examples may become apparent to those of ordinary skill in the art upon reading the foregoing description. The inventor expects skilled artisans to employ such variations as appropriate, and the inventor intends for the application to be practiced otherwise than as specifically described herein. Accordingly, this application includes all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

It will further be appreciated by those of skill in the art that the execution of the various machine-implemented processes and steps described herein may occur via the computerized execution of processor-executable instructions stored on a non-transitory computer-readable medium, e.g., random access memory (RAM), read-only memory (ROM), programmable read-only memory (PROM), volatile, nonvolatile, or other electronic memory mechanism. Thus, for example, the operations described herein as being performed by computing devices and/or components thereof may be carried out by according to processor-executable instructions and/or installed applications corresponding to software, firmware, and/or computer hardware.

The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the application and does not pose a limitation on the scope of the application unless otherwise claimed. No language in the specification should be construed as indicating any non-claimed element as essential to the practice of the application.

1. A system, comprising:
a first expired drug usability device, comprising:
a first spectrometer; and
one or more first processors configured to:
obtain at least one expired drug machine learning-artificial intelligence (ML-AI) model associated with a pharmaceutical drug;
obtain drug expiration information of a sample of the pharmaceutical drug, wherein the drug expiration information comprises spectrometer data associated with using the first spectrometer on the sample;
input the drug expiration information into the at least one expired drug ML-AI model to determine usability information associated with the sample of the pharmaceutical drug; and
perform one or more actions based on the usability information.

2. The system of claim 1, further comprising:
a second expired drug usability device, comprising:
a second spectrometer; and
one or more second processors configured to:
train the at least one expired drug ML-AI model; and
provide the at least one expired drug ML-AI model to the first expired drug usability device.

3. The system of claim 2, wherein the at least one expired drug ML-AI model comprises a spectrometer ML-AI model, and wherein the one or more second processors is configured to train the at least one expired drug ML-AI model by:
obtaining spectrometer ML-AI training information comprising spectrometer output data of the pharmaceutical drug at difference instances within a life expectancy of the pharmaceutical drug; and
training the spectrometer ML-AI model using the spectrometer ML-AI training information.

4. The system of claim 3, wherein the one or more second processors is configured to obtain the spectrometer ML-AI training information by:
obtaining first spectrometer output data of the second spectrometer associated with testing a first lot of the pharmaceutical drug, wherein the first lot of the pharmaceutical drug is at an expiration date of the pharmaceutical drug;
obtaining second spectrometer output data of the second spectrometer associated with testing a second lot of the pharmaceutical drug, wherein the second lot of the pharmaceutical drug is prior to the expiration date of the pharmaceutical drug; and
obtaining third spectrometer output data of the second spectrometer associated with testing a third lot of the pharmaceutical drug, wherein the third lot of the pharmaceutical drug is after the expiration date of the pharmaceutical drug.

5. The system of claim 3, wherein the at least one expired drug ML-AI model further comprises a signal to noise (SNR) ML-AI model, wherein the one or more second processors is configured to train the at least one expired drug ML-AI model by:
determining, based on the spectrometer output data, SNR ML-AI training information of the pharmaceutical drug at difference instances within the life expectancy of the pharmaceutical drug; and
training the SNR ML-AI model using the SNR ML-AI training information.

6. The system of claim 5, wherein the at least one expired drug ML-AI model further comprises an olfactory ML-AI model, wherein the one or more second processors is configured to train the at least one expired drug ML-AI model by:
obtaining olfactory ML-AI training information comprising olfactory sensor output data of the pharmaceutical drug at difference instances within the life expectancy of the pharmaceutical drug; and
training the olfactory ML-AI model using the olfactory ML-AI training information.

7. The system of claim 1, wherein the at least one expired drug ML-AI model comprises a spectrometer ML-AI model, a SNR ML-AI model, and an olfactory ML-AI model, and wherein the drug expiration information of the sample of the pharmaceutical drug comprises the spectrometer data of the sample of the pharmaceutical drug, SNR data of the sample of the pharmaceutical drug, and olfactory data of the sample of the pharmaceutical drug.

8. The system of claim 7, wherein the one or more first processors is configured to input the drug expiration information into the at least one expired drug ML-AI model to determine the usability information of the sample of the pharmaceutical drug by:
inputting the spectrometer data into the spectrometer ML-AI model to determine spectrometer usability information;
inputting the SNR data into the SNR ML-AI model to determine SNR usability information;
inputting the olfactory data into the olfactory ML-AI model to determine olfactory usability information; and
determining the usability information based on the spectrometer usability information, the SNR usability information, and the olfactory usability information.

9. The system of claim 8, wherein the spectrometer usability information is a first usability confidence value that is output by the spectrometer ML-AI model, the SNR usability information is a second usability confidence value that is output by the SNR ML-AI model, and the olfactory usability information is a third usability confidence value that is output by the olfactory ML-AI model.

10. The system of claim 9, wherein the one or more first processors configured to determine the usability information by:
determining the usability information as a weighted average of the first usability confidence value, the second usability confidence value, and the third usability confidence value.

11. The system of claim 1, wherein the first spectrometer is a liquid spectrometer.

12. The system of claim 1, wherein the first spectrometer is a near infrared (NIR) spectrometer.

13. A method, comprising:
obtaining, by an expired drug usability device, at least one expired drug machine learning-artificial intelligence (ML-AI) model associated with a pharmaceutical drug;
obtaining, by the expired drug usability device, drug expiration information of a sample of the pharmaceutical drug, wherein the drug expiration information comprises spectrometer data associated with using a spectrometer on the sample;
inputting, by the expired drug usability device, the drug expiration information into the at least one expired drug ML-AI model to determine usability information associated with the sample of the pharmaceutical drug; and
performing, by the expired drug usability device, one or more actions based on the usability information.

14. The method of claim 13, wherein the at least one expired drug ML-AI model comprises a spectrometer ML-AI model, and wherein the method further comprises:
obtaining spectrometer ML-AI training information comprising spectrometer output data of the pharmaceutical drug at difference instances within a life expectancy of the pharmaceutical drug; and
training the spectrometer ML-AI model using the spectrometer ML-AI training information.

15. The method of claim 14, wherein obtaining the spectrometer ML-AI training information comprises:
obtaining first spectrometer output data associated with testing a first lot of the pharmaceutical drug, wherein the first lot of the pharmaceutical drug is at an expiration date of the pharmaceutical drug;
obtaining second spectrometer output data associated with testing a second lot of the pharmaceutical drug, wherein the second lot of the pharmaceutical drug is prior to the expiration date of the pharmaceutical drug; and
obtaining third spectrometer output data associated with testing a third lot of the pharmaceutical drug, wherein the third lot of the pharmaceutical drug is after the expiration date of the pharmaceutical drug.

16. The method of claim 14, wherein the at least one expired drug ML-AI model further comprises a signal to noise (SNR) ML-AI model, wherein the method further comprises:
determining, based on the spectrometer output data, SNR ML-AI training information of the pharmaceutical drug at difference instances within the life expectancy of the pharmaceutical drug; and
training the SNR ML-AI model using the SNR ML-AI training information.

17. The method of claim 16, wherein the at least one expired drug ML-AI model further comprises an olfactory ML-AI model, wherein the method further comprises:
obtaining olfactory ML-AI training information comprising olfactory sensor output data of the pharmaceutical drug at difference instances within the life expectancy of the pharmaceutical drug; and
training the olfactory ML-AI model using the olfactory ML-AI training information.

18. The method of claim 13, wherein the at least one expired drug ML-AI model comprises a spectrometer ML-AI model, a SNR ML-AI model, and an olfactory ML-AI model, and wherein the drug expiration information of the sample of the pharmaceutical drug comprises the spectrometer data of the sample of the pharmaceutical drug, SNR data of the sample of the pharmaceutical drug, and olfactory data of the sample of the pharmaceutical drug.

19. The method of claim 18, wherein inputting the drug expiration information into the at least one expired drug ML-AI model to determine the usability information of the sample of the pharmaceutical drug comprises:
inputting the spectrometer data into the spectrometer ML-AI model to determine spectrometer usability information;
inputting the SNR data into the SNR ML-AI model to determine SNR usability information;
inputting the olfactory data into the olfactory ML-AI model to determine olfactory usability information; and
determining the usability information based on the spectrometer usability information, the SNR usability information, and the olfactory usability information.

20. A non-transitory computer-readable medium having processor-executable instructions stored thereon, wherein the processor-executable instructions, when executed, facilitate:
obtaining at least one expired drug machine learning-artificial intelligence (ML-AI) model associated with a pharmaceutical drug;
obtaining drug expiration information of a sample of the pharmaceutical drug, wherein the drug expiration information comprises spectrometer data associated with using a spectrometer on the sample;
inputting the drug expiration information into the at least one expired drug ML-AI model to determine usability information associated with the sample of the pharmaceutical drug; and
performing one or more actions based on the usability information.
